(19) United States
(12) Patent Application Publication
(10) Pub. No.: US 2010/0209158 A1
(43) Pub. Date: Aug. 19, 2010

(54) IMAGE FORMING APPARATUS AND CLEANING MECHANISM

(75) Inventor: Yoshihiko SUGIYAMA, Saitama (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/703,522

(22) Filed: Feb. 10, 2010

Related U.S. Application Data
(60) Provisional application No. 61/153,208, filed on Feb. 17, 2009.
(60) Provisional application No. 61/153,209, filed on Feb. 17, 2009.

(51) Int. Cl. G03G 21/00

(52) U.S. Cl. 399/354

(57) ABSTRACT

According to an embodiment of the present invention, there is provided a cleaning mechanism including a scraping-off member or an agitating member configured to scrape off or agitate a visualizing material present on a surface of a photoconductive member and a fiber body or a power body different from the visualizing material, a collecting member configured to store the visualizing material and the fiber body or the powder body different from the visualizing material scraped off or agitated by the scraping-off member or the agitating member, and a removing member located along the surface of the photoconductive member and at a fixed interval to the surface of the photoconductive member in a range between the scraping-off member or the agitating member and the collecting member.

### CROSS-REFERENCE TO RELATED APPLICATIONS

This application is based upon and claims the benefit of priority from: U.S. Provisional Application No. 61/153,208 filed on Feb. 17, 2009; and U.S. Provisional Application No. 61/153,209 filed on Feb. 17, 2009, the entire contents of both of which are incorporated herein reference.

### TECHNICAL FIELD

This invention relates to an image forming apparatus and a cleaning mechanism.

### BACKGROUND

It is well known that a thermofusible toner is used as a visualizing agent for visualizing an image in an image forming apparatus of an electrophotographic system.

A residual toner remaining after the toner moves to a sheet for image output remains on a photoconductive member configured to bear an image visualized by the toner.

There are various methods as a method of removing the residual toner.

JP-A-2008-209714 (Document 1) discloses a scraper configured to scrape off toner from plural brushes and a flicker roller in order to remove a residual toner on an image bearing member (an intermediate transfer belt). It is generally known that the residual toner on the image bearing member has positive and negative polarities and plural cleaning means are used for removing the residual toner.

JP-A-2008-122595 (Document 2) discloses that, in order to remove a residual toner on an image bearing member, a conductive blade configured to control (change) the charging polarity of a transfer residual toner is arranged upstream of a cleaning brush 23 and the conductive blade is swung or vibrated.

JP-A-2005-300683 (Document 3) discloses that a foreign-matter removing roller is arranged upstream of a residual toner capturing means and bias is applied to the foreign-matter removing roller to independently perform removal of a foreign matter and removal of a residual toner on a photoconductive member after transfer.

JP-A-H6-202201 (Document 4) is a prior application of the applicant and discloses that a conductive brush is arranged in a pre-process of residual toner cleaning to temporarily electrostatically attract a residual toner including foreign matters (paper scum, etc.).

Documents 1 to 3 disclose that a residual toner is removed by a cleaning mechanism of a blade cleaning system or a rotating brush system. However, according to a change in a quality of recording paper in these days, image noise is caused by a fall in cleanability due to a foreign matter such as paper scum and a toner component decomposed from toner.

The image noise caused by the fall in cleanability is not solved even by Document 4 that is the prior application of the applicant.

### SUMMARY

It is an object of the present invention to provide an image forming apparatus and a cleaning mechanism configured to be capable of suppressing a fall in cleanability due to a foreign matter such as paper scum due to a change in a quality of recording paper in these days and a toner component decomposed from toner and image noise caused by the fall in cleanability.

The present invention provides a cleaning apparatus including: a scraping-off member or an agitating member configured to scrape off or agitate a visualizing material present on a surface of a photoconductive member and a fiber body or a power body different from the visualizing material; a collecting member configured to store the visualizing material and the fiber body or the powder body different from the visualizing material scraped off or agitated by the scraping-off member or the agitating member; and a removing member located along the surface of the photoconductive member or at a fixed interval to the surface of the photoconductive member in a range between the scraping-off member or the agitating member and the collecting member.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DESCRIPTION OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram of an example of an image forming apparatus (Multi-Functional peripheral (MFP)) according to an embodiment of the present invention;

FIG. 2 is a diagram of a state of an image forming unit (a component used for processes of development, cleaning, and transfer) included in the image forming apparatus shown in FIG. 1;

FIG. 3 is a diagram of a state of a cleaning component included in the image forming unit shown in FIG. 2;

FIG. 4 is a diagram of a state of a transfer component and a peeling component included in the image forming unit shown in FIG. 2;

FIG. 5 is a diagram of an example of a configuration for removing a foreign matter from a photoconductive member in the cleaning component shown in FIG. 3;

FIG. 6 is a diagram of another example of the configuration for removing a foreign matter shown in FIG. 5;

FIG. 7 is a diagram of an example of a configuration not requiring bias voltage (causing a potential difference between the ground and toner) in the configuration for removing a foreign matter shown in FIG. 5;

FIG. 8 is a diagram of still another example of the configuration for removing a foreign matter shown in FIG. 5;

FIG. 9 is a diagram of still another example of the configuration for removing a foreign matter shown in FIG. 5;

FIG. 10 is a diagram of still another example of the configuration for removing a foreign matter shown in FIG. 5;

FIG. 11 is a diagram of still another example of the configuration for removing a foreign matter shown in FIG. 5;

FIG. 12 is a diagram of still another example of the configuration for removing a foreign matter shown in FIG. 5;

FIG. 13 is a diagram of still another example of the configuration for removing a foreign matter shown in FIG. 5; and

FIG. 14 is a diagram of an example of a characteristic of a brush member applied to the configuration for removing a foreign matter shown in FIGS. 10 and 11.

### DETAILED DESCRIPTION

An example of an embodiment of the present invention is explained in detail below with reference to the accompanying drawings.

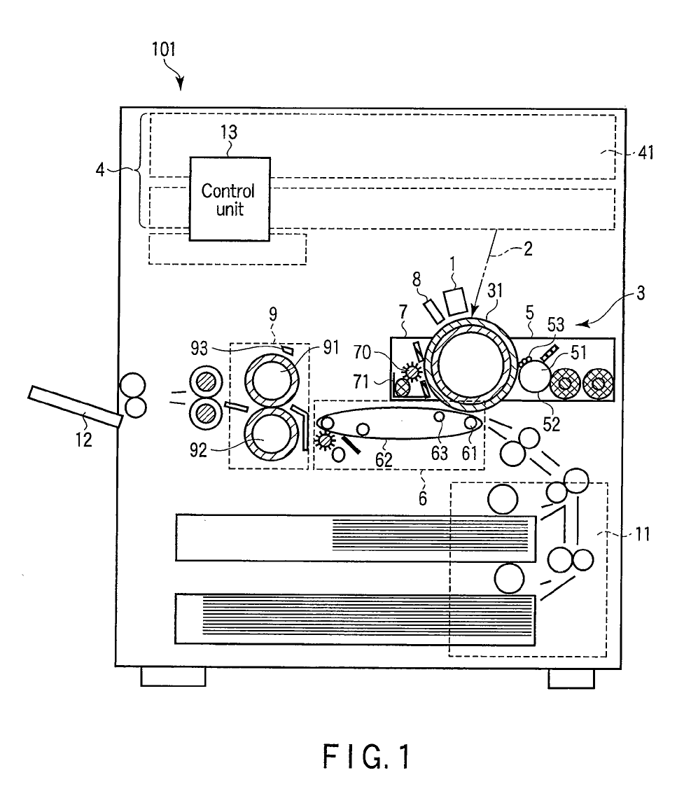

An image forming apparatus (MFP: Multi-Functional Peripheral) 101 shown in FIG. 1 includes at least a charging unit 1, a writing (exposing) unit 2, an image forming (latent image forming, developing, transferring, and cleaning) unit 3, a document reading unit 4, a developing unit 5, a transfer unit (a peeling unit) 6, a cleaning unit 7, a charge removing unit 8, and a fixing unit 9.

The charging unit 1 gives charges having predetermined polarity (in this example, “− (minus)”) to a photoconductive layer on the surface of an image bearing member, for example, a cylindrical drum 31 included in the image forming unit 3 explained below. The image bearing member is not limited to the cylindrical drum and may be an endless belt or a cylindrical drum member located on the inner side of the endless belt.

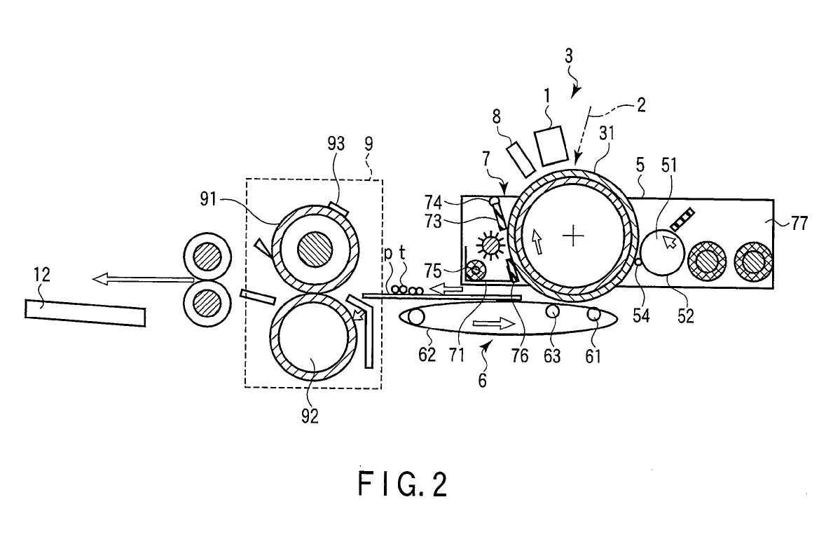

The writing (exposing) unit 2 irradiates exposure light, for example, a laser beam, light intensity of which changes according to image information as a target of image formation, on the photoconductive layer on the surface of the cylindrical drum (hereinafter referred to as photoconductive drum) 31 charged by the charging unit 1 and changes the potential of the photoconductive layer. A latent image is formed in a section where the potential is changed. The image information is provided by the document reading unit 4 explained below or a not-shown external apparatus such as a PC (Personal Computer) or a facsimile. The photoconductive drum 31 has an external diameter of, for example, 100 mm and includes a photoconductive layer 33 on the surface of a metal substrate (a hollow aluminum) 32 as indicated by an example shown in FIG. 4. The photoconductive layer 33 includes, for example, an organic photoconductive member (OPC). The metal substrate 32 is electrically grounded (connected) to a housing unit of an image forming apparatus main body as explained below with reference to FIG. 2.

The image forming (latent image forming, developing, transferring, and cleaning) unit 3 conveys a toner image obtained by developing (visualizing) the latent image with toner (a visualizing agent) provided by the developing device 5 to the transfer unit 6, the cleaning unit 7, and the charge removing unit 8 according to the rotation of the image forming unit 3. The photoconductive drum 31 rotates, for example, clockwise (in a CW (clockwise) direction) at predetermined speed.

The document reading unit 4 includes a document reading device 41. The document reading device 41 includes, for example, a CCD sensor with 600 dpi (dots per inch)/7500 pixels (a total number of pixels in a longitudinal direction thereof) and converts image information as a reflected light signal of irradiated light into an electric signal.

The developing unit 5 includes a magnet roller 51 and a developing sleeve 52 that is located on the outer circumference of the magnet roller 51 and rotates on the outer circumference. The magnet roller 51 selectively provides toner 53, which moves on the surface of the developing sleeve 52 according to the rotation of the developing sleeve 52, to the latent image on the surface of the photoconductive drum 31 while magnetically attracting the toner 53. A space between the developing sleeve 52 and the photoconductive drum 31 is managed by a guide roller 54 set in contact with the surface of the photoconductive drum 31. The developing sleeve 52 is formed of a nonmagnetic material such as stainless steel or aluminum.

The transfer unit (the peeling unit) 6 moves, with an electric field provided by a transfer roller 61, the toner image onto a sheet conveyed by a sheet conveying belt 62 (toners forming the toner image subjected to the electric field provided by the transfer roller 61 move to the sheet). A peeling unit 63 separates the toner (the toner image) and the sheet from the surface of the photoconductive drum 31.

In the cleaning unit 7, a waste toner and foreign matter storing unit 71 stores a transfer residual toner (a waste toner), fiber pieces of a sheet, a surface coating agent, or the like scraped off by a removing mechanism 70 such as a brush member (or a brush roller having a cylindrical brush) or a foreign matter conveyed together with the sheet.

The charge removing unit 8 resets the potential of the photoconductive layer on the surface of the image bearing member 31 to an initial state before the charging by the charging unit 1 (removes residual charges on the photoconductive member). The charge removing unit 8 includes an LED array in which LED elements configured to output red light having wavelength longer than, for example, 770 nm are arranged in an axis direction of the drum 31.

When the sheet that bears the toner image (the toner) passes between a fixing roller 91 configured to come into contact with the toner and a pressing roller 92 configured to apply pressure to the fixing roller 91, the fixing unit 9 provides pressure and heat and fixes the toner (the toner image) on the sheet. The fixing roller 91 is a cylinder formed of, for example, aluminum and, although not shown in the figure, includes a heater (a heating mechanism) therein. The heating mechanism may be prepared along the outer circumference of the roller 91. The heat provided to the sheet and the toner (the temperature of the fixing roller 91) is detected by a temperature sensor 93. An output of a heating device is controlled by a control unit 13 not explained in detail, whereby the heat is set within a fixed range. The temperature of the fixing roller 91 is different depending on a characteristic of toner. Although not shown in the figure, the pressing roller 92 applies predetermined pressure to the fixing roller 91 with, for example, a spring and a roller supporting mechanism configured to direct the pressure from the spring to the fixing roller 91.

As shown in FIG. 2, the photoconductive drum 31 is located rotatably with respect to a cleaner case 77 by a bearing and a drum shaft not shown in the figure.

A cleaning blade 73 is fixed to a not-shown base plate (a supporting member). The base plate is fixed to a fulcrum 74 of the cleaner case 77. Consequently, the tip of the blade 73 is pressed against the surface of the drum 31 by a not-shown pressing member such as a spring in a direction counter to a direction in which the photoconductive drum 31 rotates.

The photoconductive drum 31 is located in a predetermined position in the cleaner case 77 such that the cleaning blade 73 can come into contact with the surface of the photoconductive drum 31.

The photoconductive drum 31, the charging unit 1, the charge removing unit 8, and the cleaning unit 7 are incorporated in the cleaner case 77 and are substantially integral. In the cleaner case 77, an auger 75 configured to convey a waste toner and a not-shown discharge unit cover are further prepared. A not-shown discharge unit of the cleaner case 77 is connected to a not-shown waste toner storing unit.

As explained above, as the main configuration, the image forming unit 3 includes the photoconductive drum 31, the cleaning unit 7, the charging unit 1, and the charge removing unit 8 and is collectively detachably attachable to the image forming apparatus main body. This makes it easy to mechanically and electrically connect the image forming unit 3 to the image forming apparatus main body. Specifically, the photoconductive drum 31 can rotate with driving force of a not-shown driving unit on the image forming apparatus main body side. The charging unit 1, the charge removing unit 8, the cleaning unit 7, the transfer unit 6, and the like are electrically grounded (connected) to the housing unit of the image forming apparatus main body.

The image forming apparatus 101 further includes a paper feeding unit 11 configured to feed a sheet to the transfer unit 6 of the image forming unit 3 and a paper discharge unit 12 configured to receive a sheet on which a toner image is fixed by the fixing unit 9. The image forming apparatus forms a toner image corresponding to image information provided by the document reading device 41 of the document reading unit 4 or a not-shown external apparatus such as a PC (Personal Computer) or a facsimile.

Specifically, when image formation is instructed from an operation unit or an external apparatus not shown in the figure, process control by the image forming unit 3 and fixing temperature control by the fixing unit 9 are started according to the control by the control unit 13. A copy output or a printout (a print output) is output by, for example, latent image formation, development, transfer, and cleaning in the image forming unit 3, movement of the toner image to the sheet from the paper feeding unit 11 by the transfer and peeling unit 6, and sheet conveyance control according to image information input by the document reading device 41 or the not-shown external apparatus.

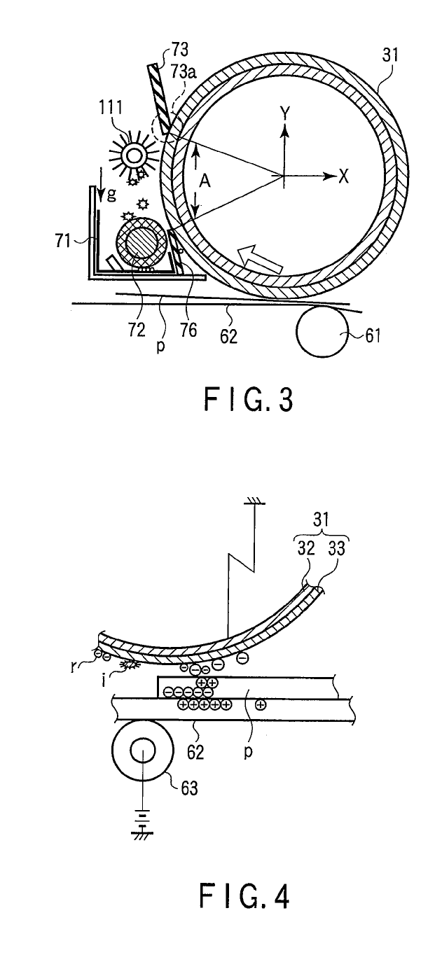

A characteristic of the cleaning unit is explained below with reference to FIG. 3.

The cleaning unit 7 includes the cleaning blade 73 that scrapes off a residual toner remaining on the drum surface after toner moves from the photoconductive drum 31 to a sheet.

A foreign-matter removing unit 111 is located near the cleaning blade 73 (when the photoconductive drum 31 rotates, further on an upstream side in a rotating direction than the cleaning blade 73). The foreign-matter removing unit 111 is preferably located in a section along the surface of the photoconductive drum 31 between a position where the cleaning blade 73 and the photoconductive drum 31 are set in contact with each other and a transfer position where the toner moves from the photoconductive drum 31 to the sheet (a position where the transfer roller 61 and the photoconductive drum 31 are set in contact with each other). The foreign-matter removing unit 111 is more preferably located in a range between a seal material 76, which is configured to prevent the toner scraped off by the cleaning blade 73 from leaking to the outside of the cleaner case 77 along the outer circumference of the photoconductive drum 31, and the cleaning blade 73, i.e., a range indicated by A in the figure.

The foreign-matter removing unit 111 is obtained by, for example, forming conductive fiber in a brush shape. The tip of the brush (fiber) is located in a position not in contact with the surface of the photoconductive drum 31. The foreign-matter removing unit 111 rotates to move, in a position near the surface of the photoconductive drum 31, in a direction opposite to a direction in which the surface of the photoconductive drum 31 moves (by rotating). In other words, rotating directions of the photoconductive drum 31 and the foreign-matter removing unit 111 around the respective axes thereof are the same. The foreign-matter removing unit 111 is configured to drop the foreign matter or the residual toner, which is scraped off by the foreign-matter removing unit 111, in the gravity direction that is an arrow g direction (cause the foreign matter or the residual toner to free fall).

The residual toner scraped off by the foreign-matter removing unit 111 is conveyed to a not-shown residual-toner storing unit via a residual-toner conveying roller 72. The residual-toner conveying roller 72 is provided in a position where the toner or the foreign mater scraped off by the foreign-matter removing unit 111 free falls. This makes it possible to configure the cleaning unit 7 in a horizontal drawing structure that can slide along the axis direction of the photoconductive drum 31 and from which the toner or the foreign matter does not easily spill when the cleaning unit 7 is attached and detached.

FIG. 4 is a diagram for explaining characteristics of the transfer unit and the peeling unit.

Charges from the transfer roller 61 (see FIG. 3), to which voltage having polarity opposite to that of toner is applied, flow to the sheet conveying belt 62 and then flows to a sheet and the photoconductive drum 31. Consequently, a toner image (a visible image) formed on the surface of the photoconductive drum 31 is transferred onto the charged sheet.

The sheet is electrostatically attracted to the surface of the photoconductive drum 31 while bearing the toner image. Therefore, polarization charge (in this example, “− (minus)”) is generated on the lower surface of the sheet by the peeling unit 63. The sheet is attracted to the sheet conveying belt 62 by electrostatic attraction acting between the peeling unit 63 and the sheet conveying belt 62 and separated from the photoconductive drum 31.

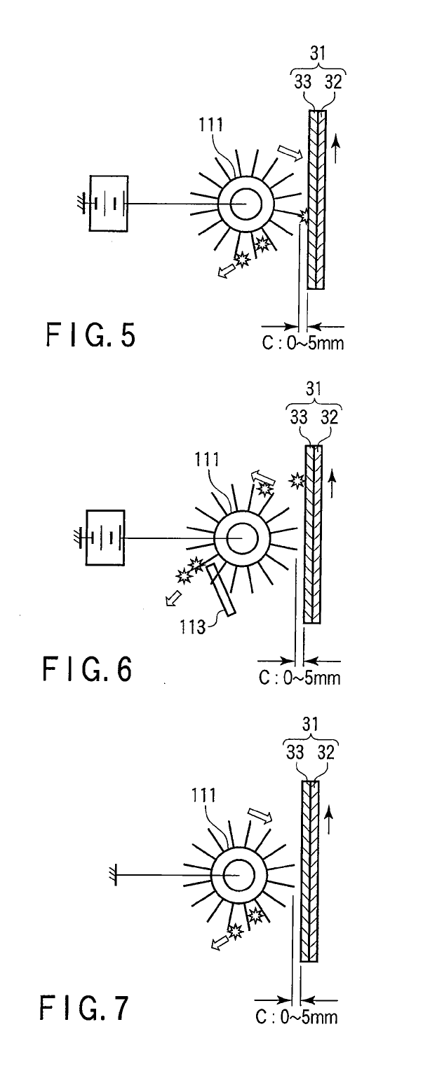

TABLE 1
*Example

| | |
|---|---|
| Experiment | The image forming apparatus in which the urethane |
| condition | cleaning blade was set in contact with the two- |
| | component developer and the drum-like |
| | photoconductive member (see FIG. 1) |
| Drum-like | The organic photoconductive member (OPC) formed |
| photoconductive | by processing of different four layers on an aluminum |
| member | element pipe, external diameter 100 mm (concerning |
| | a rotating direction, see FIG. 3) |
| Foreign-matter | A cored bar was a stainless steel pipe, thickness |
| removing unit | 1 mm, inner diameter 6 mm (concerning a rotating |
| | direction, see FIG. 3) |
| | Brush raw fabric was conductive acrylic fiber, pile |
| | density 50,000/inch2 |
| | Brush resistance was 10 to 10 Ω under 20° C./60% |
| | RH environment |
| Foreign-matter | The foreign-matter removing unit was arranged in |
| removing unit | the A range between the cleaning blade and the seal |
| arrangement | under the drum. |
| | An attaching distance between the drum-like |
| | photoconductive member and the foreign-mater |
| | removing unit was C (0 to 5 mm). (See FIGS. 5 and |
| | 6) |
| Applied | The drum-like photoconductive member was |
| voltage | grounded. The foreign-matter removing unit was set |
| | to −400 V to 400 V |
| Recording | Two types, recording paper A and recording paper B |
| paper | |
| *Checking | 1) As a test of cleanability, an original document is |
| method | continuously print-output at a printing ratio of 50% by |
| | an actual machine and a black streak in an image |
| | due to a cleaning failure is visually checked. |
| | 2) Transfer efficiency was forcibly set to a condition |
| | of about 70%, a residual toner amount on the drum |
| | was set rather larger (not transferred), and a sheet |
| | was sent to a cleaning point. |
| | 3) Presence or absence of the foreign-matter |
| | removing unit and an effect by applied voltage were |
| | checked. |

TABLE 2

| Presence or | | | | | | | | |
|---|---|---|---|---|---|---|---|---|
| absence of the | | Recording paper A | | | Recording paper B | | | |
| foreign-matter | | Applied voltage | | | Applied voltage | | | |
| removing unit | | −400 V | 0 V | +400 V | −400 V | 0 V | +400 V | What is found |
| Foreign-matter | | C | C | C | B | B | B | There is a difference |
| removing unit | | | | | | | | depending on |
| is absence (no | | | | | | | | recording paper |
| application) | | | | | | | | |
| Foreign-matter | C = 0 mm | B | A | A | A | A | A | Drum scratch |
| removing unit | | | | | | | | occurred |
| is present | C = 1 mm | A | A | A | A | A | A | |
| | C = 2 mm | B | A | A | A | A | A | |
| | C = 3 mm | B | A | B | B | A | A | Foreign matters |
| | C = 4 mm | B | B | B | B | B | B | accumulate in the |
| | | | | | | | | foreign-matter |
| | | | | | | | | removing unit |
| | C = 5 mm | C | B | B | B | B | B | Fine fiber of |
| | | | | | | | | recording paper |
| | | | | | | | | slipped through |

Notice:
“A” indicates “excellence”;
“B” indicates “as usual”; and
“C” indicates “not excellence.”

FIG. 5 is a diagram of an example of arrangement of the foreign-matter removing unit schematically shown in FIG. 3.

The foreign-matter removing unit 111 is obtained by using, for example, a cylindrical stainless steel material as a core bar and fixing a brush made of pile conductive acrylic fiber (e.g., AS-7/10D manufactured by Toray Industries, Inc.) to the core bar section in, for example, a right winding direction in a spiral shape by adhesion, hot melt, or the like. Row fabric of the brush has width of, for example, 20 mm to 30 mm. A space in winding the conductive acrylic fiber in a spiral shape is desirable 2 mm to 3 mm.

As explained above, the foreign-matter removing unit 111 rotates, for example, CW (clockwise) in the position near the surface of the photoconductive drum 31 to move in the direction opposite to the direction in which the surface of the photoconductive drum 31 moves (by rotating). The foreign-matter removing unit 111 and the surface of the photoconductive drum 31 is desirably not in contact with each other (a C value is equal to or smaller than 5 mm). By setting the C value larger than 0 mm in this way, it is possible to prevent the surface of the photoconductive drum 31 from being scratched.

Voltage having polarity opposite to that of the toner is applied to the foreign-matter removing unit 111. Therefore, it is possible to attract a foreign matter mixed in a residual toner and remove a foreign matter different from the toner from the surface of the photoconductive drum 31. In the example shown in FIG. 5, the voltage application is performed via a shaft of the foreign-matter removing unit 111. In this way, the foreign-matter removing unit 111 can prevent a residual toner r including a foreign mater i such as paper scum from reaching a cleaning point 73a where the cleaning blade 73 is set in contact with the surface of the photoconductive drum 31.

After the foreign-matter removing unit 111 attracts the foreign matter different from the toner, the residual toner not mixed with the foreign matter passes through the foreign-matter removing unit 111 (slips through the gap between the photoconductive drum 31 and the foreign-matter removing unit 111) and is scraped off by the cleaning blade 73.

To prevent fiber of a sheet or the like from clogging the brush of the foreign-matter removing unit 111, as shown in FIG. 6, it is desirable to set a foreign-matter-removing-unit assisting sheet metal 113 in contact with the brush of the foreign-matter removing unit 111 to remove the foreign matter attracted by the foreign-matter removing unit 111.

In an example shown in FIG. 6, compared with the example shown in FIG. 5 in which the foreign-matter-removing-unit assisting sheet metal 113 is not used, it is possible to further prevent the foreign matter from reaching the cleaning point 73a (see TABLE 1 and TABLE 2 of an experimental example).

As indicated by an example shown in FIG. 7, even when the foreign-matter removing unit 111 schematically shown in FIG. 5 is set to the ground (0V) without being applied with voltage for foreign matter attraction from a voltage supply source on the outside, the foreign-matter removing unit 111 can separate the residual toner and the foreign matter on the photoconductive drum 31. Although not shown in the figure, in the same manner as shown in FIG. 6, it is desirable to prevent fiber of a sheet or the like from clogging the brush of the foreign-matter removing unit 111 by providing the foreign-matter-removing-unit assisting sheet metal (113).

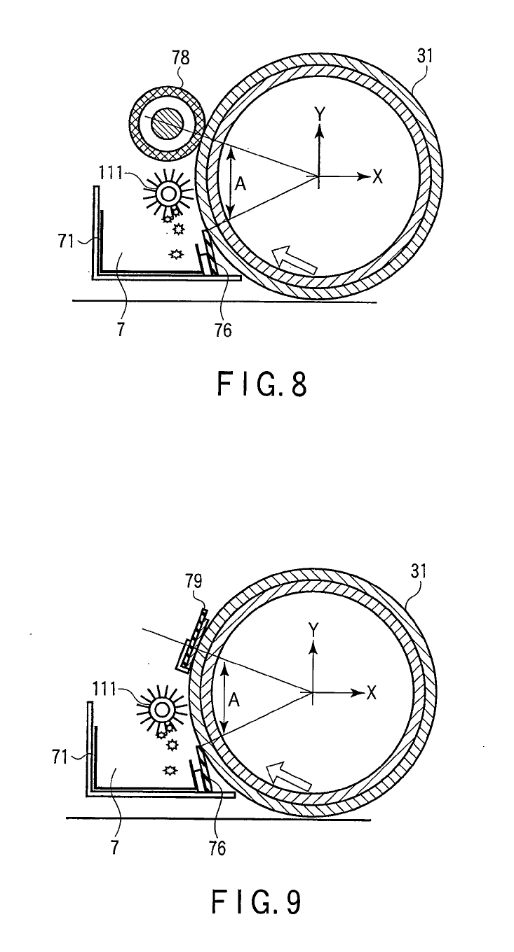

FIGS. 8 and 9 are diagrams of another example of a position suitable for arranging the foreign-matter removing unit. In FIGS. 8 and 9, an example of a cleaner-less structure is shown in which the cleaning blade 73 used by the cleaning unit shown in FIG. 3 is replaced with a (brush) roller 78 or a brush 79 functioning as a memory removing unit. In the example shown in FIGS. 8 and 9, the foreign-matter removing unit 111 is located between the seal material 76, which is configured to prevent toner from leaking to the outside of the cleaner case 77 along the outer circumference of the photoconductive drum 31, and the cleaning blade 73, i.e., a range indicated by A.

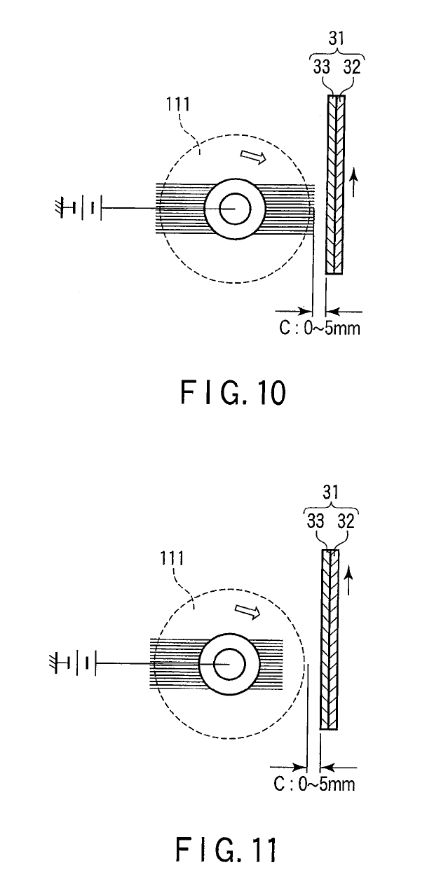

FIGS. 10 and 11 are diagrams of other examples of the foreign-matter removing unit. It is more effective to use the foreign-matter removing unit shown in FIGS. 10 and 11 in combination with the cleaner-less structure explained with reference to FIGS. 8 and 9.

In the example of the foreign-matter removing unit shown in FIG. 10, as indicated by details shown in FIG. 14, a brush member 121 (equivalent to the foreign-matter removing unit 111) formed in a brush shape at density of 86 bundles/inch by binding, for example, 100 pieces of fiber of rayon containing carbon at specific resistance of 10⁶ Ω·cm and thickness of 6 D (denier) as one bundle. The brush member 121 is rotated without the tip thereof coming into contact with the surface of the photoconductive drum 31. The brush member 121 includes a brush 123 that is the bundle of conductive fiber explained above. The same effect is obtained when the conductive fiber is changed to a conductive member (a material) such as a rubber sheet or a sponge material.

The brush 123 of the brush member 121 is prevented from falling to the downstream side in the rotating direction by a brush backing seal material 125 obtained by cutting the tip of a polyester sheet having thickness of, for example, 0.1 mm in a comb shape. The brush-backing seal material 125 is desirably set in a state in which the bristle end (the tip) of the brush 123 projects about 1 mm (a state in which the brush-backing seal material 125 is shorter than the brush 123). However, the brush-backing seal material 125 also needs to be not set in contact with the surface of the photoconductive drum 31.

Pressing pressure of the brush-backing seal material 125 is desirably 5 mN/mm to 40 mN/mm. A C value thereof is larger than 0 mm and is about 5 mm in the same manner as shown in FIGS. 5, 6, and 7.

The brush 123 and the brush-backing seal material 125 are firmly fixed by, for example, a retainer 127 made of stainless steel. As a rotation fulcrum, a core bar section 129 is provided in the retainer 127.

In the example shown in FIG. 11, the brush shape is changed in the foreign-matter removing unit (the brush member) shown in FIG. 10. The length of the brush on one end side is set short compared with the length of the brush on the other end side.

When the brush-like foreign-matter removing unit shown in FIGS. 10 and 11 is used, if “latent image formation, development, transfer, and cleaning” by the image forming unit 3 is set as an image forming cycle, the photoconductive drum 31 is normally rotated (or reversely rotated) in a cycle other than the image forming cycle (in a non-image forming cycle). This also makes it possible to move foreign matters accumulated at the tip of the foreign-matter removing unit 111 (the brush member 121) in the gravity direction indicated by the arrow g and drop the foreign matters onto the residual-toner conveying roller 72. The cycle other than the image forming cycle includes, for example, operations during starting after power-on of the image forming apparatus 101, before execution of an image forming job, and at the end of the image forming job. In the example shown in FIG. 10, an example in which voltage having polarity opposite to that of toner is applied to the foreign-matter removing unit 111. In the example shown in FIG. 11, the foreign-matter removing unit 111 is grounded and a predetermined potential difference is applied between the ground and the charging potential of the toner.

The reverse rotation of the photoconductive drum 31 is also useful in collecting, in the configuration for using the cleaning unit 7 explained with reference to FIGS. 5, 6, and 7, a slight foreign matter that reaches the cleaning point 73a at the tip of the cleaning blade 73 or a foreign matter that may adhere to the cleaning point 73a at the tip of the cleaning blade 73.

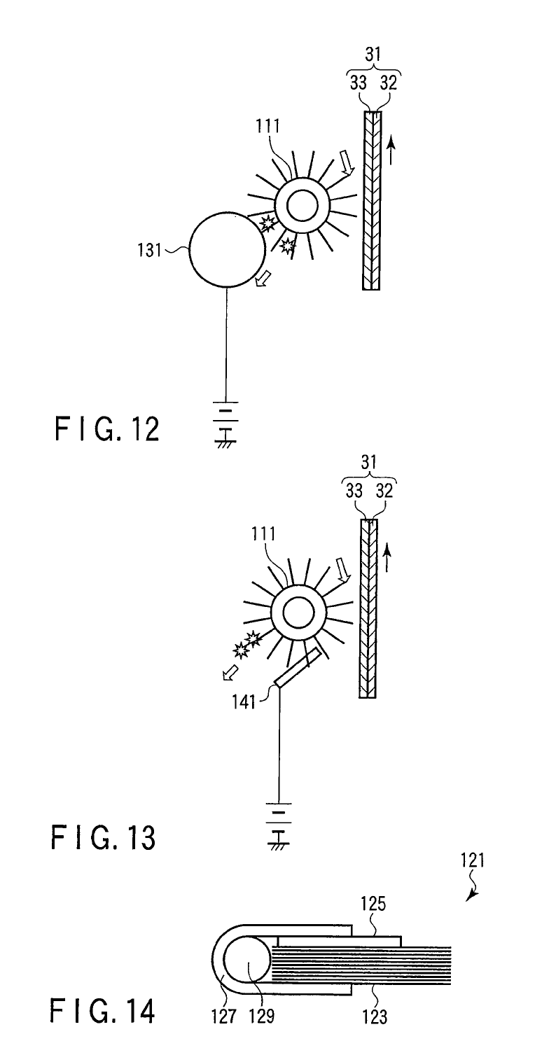

FIGS. 12 and 13 are diagrams of examples of a configuration for removing a foreign matter attracted by the foreign-matter removing unit shown in FIGS. 10 and 11 and reducing clogging of the conductive foreign-matter removing unit 111 (brush member 121). In the example shown in FIG. 12, for example, a cylindrical shaft 131 of a stainless steel material is set in contact with the brush tip of the conductive brush member 121 under a fixed condition (pressure or length) to remove a foreign matter attracted by the foreign-matter removing unit 111 (the brush member 121). It goes without saying that the foreign matter can be efficiently removed by applying predetermined voltage to the shaft 131. Similarly, in the example shown in FIG. 13, for example, a plate (an assisting sheet metal) 141 of a stainless steel material is located on a center side of the foreign-matter removing unit 111 by a fixed length from the brush tip of the foreign-matter removing unit 111 (the brush member 121) and load is applied to the tip of the foreign-matter removing unit 111 by the assisting sheet metal 141 to remove a foreign matter attracted by the foreign-matter removing unit 111. It goes without saying that the foreign matter can be efficiently removed by applying predetermined voltage to the assisting sheet metal 141.

However, as a cut-in amount of the shaft 131 or the assisting sheet metal 141, i.e., an assisting unit, shown in FIG. 12 or 13 into the center side of the foreign-matter removing unit 111 is larger, there is a larger effect of voltage application but, in some case, surface properties of the foreign-matter removing unit 111 are damaged. For example, when a material of the foreign-matter removing unit 111 is a brush or a sponge material, in some case, cutting scum (a broken piece) of the material reaches the cleaning blade 73 and affects a cleaning function. Therefore, taking a conductive brush as an example, it is desirable to hold down the cut-in amount to about 10% at the maximum compared with the total length of the brush. For example, when a diameter of a circle defined by the outermost circumference of a circle of the rotation of the foreign-matter removing unit 111 is 20 mm to 30 mm, a maximum value of the cut-in amount is suitably 2 mm to 3 mm.

When the brush-like foreign-matter removing unit shown in FIGS. 10 and 11 are (fixedly) arranged without being rotated, it is desirable to reciprocatingly move the assisting unit shown in FIGS. 12 and 13, for example, in a longitudinal direction thereof using a not-shown driving mechanism (e.g., a cam mechanism) to scrape off a foreign matter different from the toner attracted by the foreign-matter removing unit.

As explained above, in the cleaning apparatus configured to remove a residual toner and a foreign matter such as paper scum from the photoconductive layer of the photoconductive drum (the image bearing member), the foreign-matter removing unit configured to remove the foreign matter such as paper scum is provided at the pre-stage of the cleaning point where the cleaning blade and the surface of the photoconductive drum are set in contact with each other. This makes it possible to keep stable cleanability. The cleaning unit is set in contact with the surface of the image bearing member in the direction counter to the moving direction of the surface.

The foreign-matter removing unit is desirably not set in contact with the surface (the photoconductive layer) of the image bearing member.

Clogging of the foreign-matter removing unit is desirably suppressed by the assisting unit such as a scraper (a metal plate or a metal cylinder). Voltage having polarity opposite to that of toner may be applied to the assisting unit. The assisting unit may be grounded to secure a potential difference between the assisting unit and the potential of the toner. Specifically, only the residual toner remains on the photoconductive layer on the surface of the image bearing member. Therefore, it is possible to control, with a cleaning assisting unit, the residual toner to polarity or potential for easy removal of the residual toner from the surface of the image bearing member and surely collect the residual toner with the cleaning unit.

It is possible to move a foreign mater staying at the cleaning point or attracted to the cleaning point by normally or reversely rotating the image bearing member at non-image forming time.

A collecting unit can collect the foreign matter removed from the surface (the photoconductive layer) of the image bearing member by causing the foreign matter to free fall.

The foreign matter that finished passing between the foreign-matter removing unit and the surface of the image bearing member can be collected by the collecting unit according to the free fall before the foreign matter reaches the cleaning point where the cleaning blade and the surface of the image bearing member are set in contact with each other. Therefore, an amount of the foreign matter reaching the cleaning point is very small.

The assisting unit is formed in a roller or plate shape and performs agitation of the residual toner and polarity change (application of opposite polarity voltage). The assisting unit can be arranged at the pre-stage or the post-stage of the foreign-matter removing unit or both the pre-stage and the post-stage. The assisting unit may be an elastic member.

A vertical line of the foreign-matter removing unit is set to coincide with, in the gravity direction, two imaginary lines (X (a horizontal line)) and (Y (a vertical line)) that pass the center of the image bearing member and are orthogonal to each other.

The foreign-matter removing unit is located in a range of an angle A defined by the seal material, which prevents toner moving together with the image bearing member from dropping along the surface of the image bearing member, and the cleaning unit with respect to the two imaginary lines (X (the horizontal line)) and (Y (the vertical line)) that pass the center of the image bearing member and are orthogonal to each other.

In the cleaner-less structure in which the memory removing unit is arranged instead of the cleaning blade, the foreign-matter removing unit configured to remove a foreign matter such as paper scum is provided at the pre-stage of the position where the surface of the photoconductive drum and the memory removing unit are near to each other. This makes it possible to kept stable cleanability.

The residual toner is reusable and the cleaner-less mechanism can be realized. A toner conveying mechanism is unnecessary.

Only the residual toner remains on the photoconductive layer on the surface of the image bearing member. Therefore, the reusability of the residual toner can be facilitated by setting, with the cleaning assisting unit, the residual toner to polarity or potential for easy removal of the residual toner from the surface of the image bearing member (securing a potential difference between the potential of the residual toner and the potential of the toner).

The foreign matter removed from the surface (the photoconductive layer) of the image bearing member can be collected by the collecting unit by causing the foreign matter to free fall.

The cleaning assisting unit and the foreign-matter removing unit have different combination effects. It is possible to change a combination of arrangement thereof in the range of the angle A according to a process of the image forming apparatus.

As explained above, in the cleaning mechanism according to the embodiment, it is possible to prevent an image failure (a black streak due to a cleaning failure, etc.) from occurring because of the influence of a foreign-matter such as paper scum caused by image formation on various kinds of sheets.

In particular, it is possible to surely prevent the image failure from occurring by using means for removing the foreign matter (paper scum, etc.) separately from means for removing the residual toner (about 6 μm to 15 μm).

The configuration of this proposal is particularly useful in the image forming apparatus that uses the cleaner-less mechanism.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A cleaning apparatus comprising:
a scraping-off member or an agitating member configured to scrape off or agitate a visualizing material present on a surface of a photoconductive member and a fiber body or a power body different from the visualizing material;
a collecting member configured to store the visualizing material and the fiber body or the powder body different from the visualizing material scraped off or agitated by the scraping-off member or the agitating member; and
a removing member located along the surface of the photoconductive member or at a fixed interval to the surface of the photoconductive member in a range between the scraping-off member or the agitating member and the collecting member.

2. The apparatus of claim 1, wherein the removing member has potential of polarity different from potential of the visualizing material.

3. The apparatus of claim 1, wherein the removing member has a predetermined potential difference with respect to potential of the visualizing material.

4. The apparatus of claim 1, wherein the removing member includes a cylindrical rotating brush.

5. The apparatus of claim 1, wherein the removing member includes a tabular rotating brush.

6. The apparatus of claim 5, wherein the removing member has potential of polarity different from potential of the visualizing material.

7. The apparatus of claim 6, wherein the removing member has a predetermined potential difference with respect to the potential of the visualizing material.

8. The apparatus of claim 1, wherein the removing member causes the visualizing material and the fiber body or the powder body different from the visualizing material scraped off or agitated by the scraping-off member or the agitating member to free fall to the collecting member.

9. The apparatus of claim 1, wherein the removing member is located along the surface of the photoconductive member and at the fixed interval to the surface of the photoconductive member between the scraping-off member or the agitating member and a transfer position where the visualizing material born on the surface of the photoconductive member is moved to a transfer medium.

10. The apparatus of claim 9, wherein the removing member causes the visualizing material and the fiber body or the powder body different from the visualizing material scraped off or agitated by the scraping-off member or the agitating member to free fall to the collecting member.

11. The apparatus of claim 1, further comprising an assisting member configured to remove the fiber body or the powder body different from the visualizing material from the removing member.

12. The apparatus of claim 11, wherein the assisting member applies potential of polarity different from potential of the visualizing material to the removing member.

13. The apparatus of claim 11, wherein the assisting member gives a predetermined potential difference with respect to potential of the visualizing material to the removing member.

14. The apparatus of claim 1, wherein the scraping-off member or the agitating member is set in contact with the surface of the photoconductive member and removes the visualizing material present on the surface of the photoconductive member.

15. The apparatus of claim 1, wherein the scraping-off member or the agitating member is set near the surface of the photoconductive member at a predetermined interval and the visualizing material present on the surface of the photoconductive member passes a gap between the scraping-off member or the agitating member and the surface of the photoconductive member.

16. A method for cleaning toner and other particles comprising:
removing the particles adhering to a surface of a photoconductive member using a removing member located along the surface of the photoconductive member and at a fixed interval to the surface of the photoconductive member; and
receiving the toner present on the surface of the photoconductive member.

17. An image forming apparatus comprising:
a photoconductive member configured to bear a latent image;
a developing mechanism configured to supply a visualizing material to the latent image born by the photoconductive member (and develop the latent image); and
a cleaning mechanism including:
a scraping-off member or an agitating member configured to scrape off or agitate a visualizing material present on the photoconductive member and a fiber body or a power body different from the visualizing material;
a collecting member configured to store the visualizing material and the fiber body or the powder body different from the visualizing material scraped off or agitated by the scraping-off member or the agitating member; and
a removing member located along a surface of the photoconductive member and at a fixed interval to the surface of the photoconductive member in a range between the scraping-off member or the agitating member and the collecting member.

18. The apparatus of claim 17, wherein the removing member causes the visualizing material and the fiber body or the powder body different from the visualizing material scraped off or agitated by the scraping-off member or the agitating member to free fall to the collecting member.

19. The apparatus of claim 17, wherein the removing member is located along the photoconductive member and at the fixed interval to the photoconductive member between the scraping-off member or the agitating member and a transfer position where the visualizing material born by the photoconductive member is moved to a transfer medium.

20. The apparatus of claim 17, further comprising an assisting member configured to remove the fiber body or the powder body different from the visualizing material from the removing member.
